(19) United States
(12) Patent Application Publication
(10) Pub. No.: US 2023/0251641 A1
(43) Pub. Date: Aug. 10, 2023

(54) SIMULATION FOR AUTHENTICATING SERVICE MACHINES

(71) Applicant: INTERNATIONAL BUSINESS MACHINES CORPORATION, ARMONK, NY (US)

(72) Inventors: Shailendra Moyal, Pune (IN); Saraswathi Sailaja Perumalla, Visakhapatnam (IN); Venkata Vara Prasad Karri, Visakhapatnam (IN); Sarbajit K. Rakshit, Kolkata (IN)

(21) Appl. No.: 17/650,097

(22) Filed: Feb. 7, 2022

(51) Int. Cl. G05B 19/418

(52) U.S. Cl. CPC G05B 19/41885; G05B 19/4183; G05B 19/4184; G05B 19/4185

(57) ABSTRACT

A method includes responsive to identifying an industrial machine requiring assistance from a service machine, identifying a location for the industrial machine, where the location associated with an industrial setting. The method further includes identifying a plurality of available service machines to provide assistance to the industrial machine and performing a simulation of each of the plurality of available service machines based on the assistance to the industrial machine and a policy for the location. The method further includes responsive to identifying a candidate service machine from the plurality of available service machines, determining a procedure performable by the candidate service machine, where the procedure provides assistance to the industrial machine. The method further includes performing the procedure for the candidate service machine.

### BACKGROUND

This disclosure relates generally to authenticating service machines, and in particular to, authenticating service machines through simulation for interacting with an industrial machine.

Industrial machines are commonly utilized in manufacturing and warehouse settings for automating processes, where each of the industrial machines typical includes recommended maintenance intervals and a specified service life. Industrial machines typically operate for extended period of times without requiring maintenance, but instances can occur where an unexpected repair is required. An industrial machine is an example of a physical object that can be virtually represented as a digital twin. A digital twin allows for the virtual representation of the industrial object spanning the service life with updatable real-time data from the industrial object for utilization in a digital twin simulation with machine learning and reasoning to assist with decision making.

### SUMMARY

Embodiments in accordance with the present invention disclose a method, computer program product and computer system for authenticating service machines through simulation the method, computer program product and computer system can, responsive to identifying an industrial machine requiring assistance from a service machine, identify a location for the industrial machine, wherein the location associated with an industrial setting. The method, computer program product and computer system can identify a plurality of available service machines to provide assistance to the industrial machine. The method, computer program product and computer system can perform a simulation of each of the plurality of available service machines based on the assistance to the industrial machine and a policy for the location. The method, computer program product and computer system can, responsive to identifying a candidate service machine from the plurality of available service machines, determine a procedure performable by the candidate service machine, wherein the procedure provides assistance to the industrial machine. The method, computer program product and computer system can perform the procedure for the candidate service machine.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a service machine assignment program for authenticating a service machine through simulation for interacting with an industrial machine, in accordance with an embodiment of the present invention.

FIG. 3A illustrates an overhead view of a movement path associated with a procedure for a candidate service machine, in accordance with an embodiment of the present invention.

FIG. 3B illustrates an overhead view of a deviation of the movement path associated with a procedure for a candidate service machine, in accordance with an embodiment of the present invention.

FIG. 4 is a block diagram of components of a computer system, such as the server computer of FIG. 1, in accordance with an embodiment of the present invention.

FIG. 5 depicts a cloud computing environment, in accordance with an embodiment of the present invention.

FIG. 6 depicts abstraction model layers, in accordance with an embodiment of the present invention.

### DETAILED DESCRIPTION

Embodiments of the present invention provide an authentication of service machines through simulation for interacting with an industrial machine. The industrial machine represents any stationary or mobile machinery that is operational on an industrial floor, such as, a manufacturing or warehouse floor. Embodiments of the present invention identify an industrial machine currently located on the manufacturing or warehouse floor requiring assistance from a service machine and a current location for the industrial machine. The manufacturing or warehouse floor includes a policy with various rules and parameters for operating the industrial machine and any service machine assisting the industrial machine on the manufacturing or warehouse floor. Embodiments of the present invention identify service machines for assisting the industrial machine and perform a digital twin simulation on each of the identified service machines based on the assistance required by the industrial machine and the identified policy for the location. If a candidate service machine is available based on the results of the performed digital twin simulations, embodiments of the present invention determine a procedure for the candidate service machine and perform the procedure for the candidate service machine. Embodiments of the present invention monitor the procedure being performed by the candidate service machine and terminate the procedure being performed by the candidate service machine if a deviation from the procedure is detected.

Embodiments of the present invention provide various technological improvements in the general area of supply chains, specifically to efficiency and safety as it relating to industrial machinery on the manufacturing or warehouse floor. Industrial machinery typically operates for extended period of times without requiring maintenance, but instances can occur where an unexpected repair is required. Depending on the repair, the industrial machine may require removal with external service machinery (e.g., crane or lift) from the manufacturing or warehouse floor, or external service machinery may need to be brought in to perform the repair on the manufacturing or warehouse floor. To ensure down time is reduced, embodiments of the present invention utilize a digital twin simulation of the industrial machinery and the external service machinery to maximize efficiently and safety of the repair relative to a position in which the industrial machinery is located on the manufacturing or warehouse floor. Embodiments of the present invention identifies a candidate service machine for performing the repair and determines a procedure for the candidate service machine to perform the procedure efficiently and safely. Embodiments of the present invention monitor a progress of the procedure to identify any deviations from the procedure and terminate any procedure if a deviation is detected to maximize efficiency of the repair, while minimizing risk to the surrounding persons and area.

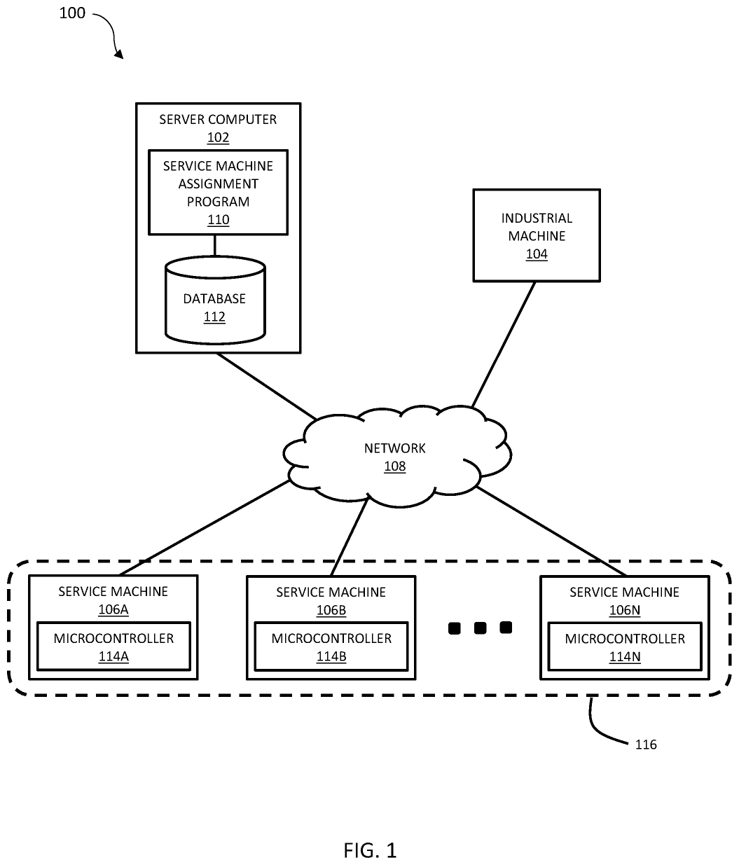

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

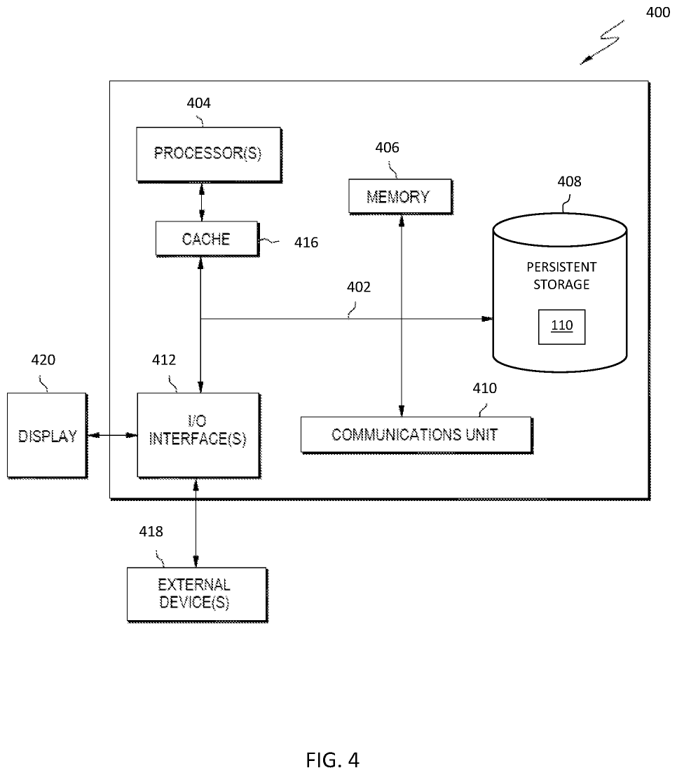

Distributed data processing environment includes server computer 102, industrial machine 104, and service machines 106A, 106B, and 106N all interconnected over network 108. Server computer 102 can be a standalone computing device, a management server, a web server, a mobile computing device, or any other electronic device or computing system capable of receiving, sending, and processing data. In other embodiments, server computer 102 can represent a server computing system utilizing multiple computers as a server system, such as in a cloud computing environment. In another embodiment, server computer 102 can be a laptop computer, a tablet computer, a netbook computer, a personal computer (PC), a desktop computer, a smart phone, or any programmable electronic device capable of communicating with industrial machine 104, service machine 106A, 106B, and 106N, and other computing devices (not shown) within the distributed data processing environment via network 108. In another embodiment, server computer 102 represents a computing system utilizing clustered computers and components (e.g., database server computers, application server computers, etc.) that act as a single pool of seamless resources when accessed within the distributed data processing environment. Server computer 102 includes service machine assignment program 110 and database 112. Server computer 102 may include internal and external hardware components, as depicted and described in further detail with respect to FIG. 4.

Industrial machine 104 represents a physical system utilizing power to apply forces and control movements to perform an action in an industrial setting, such as, a manufacturing floor or a warehouse floor. Examples of industrial machine 104 include a power generator, a press-fit machine, a fluid pump, an exhaust fan, a conveyer, a spot weld machine, a programmable robotic arm, and any other physical system capable of performing an action in an industrial setting. For the embodiments disclosed herein, industrial machine 104 is positioned within the industrial setting (i.e., on the manufacturing or warehouse floor) in which the action is being performed. In other embodiments, industrial machine 104 is located outside of the industrial setting. Industrial machine 104 includes various configurable and serviceable mechanical and electrical components, where service machine 106A, 106B, and 106N are available for configuring and servicing the mechanical and electronical components. Service machine 106 represents a physical system utilizing power to apply forces and control movements to perform an action with respect to industrial machine 104. Examples of service machine 106 include a mobile crane, a powered forklift, a powered lift truck, a powered jack, and any other physical system capable of performing an action with respect to industrial machine 104. The action performable by service machine 106 can include lifting industrial machine 104, relocating industrial machine 104, assembling components on industrial machine 104, disassembling components on industrial machine 104, or any other physically performable action on industrial machine 104.

It is to be noted, service machine 106 represents a single physical system, where service machine 106A represents a first physical system, service machine 106B represents a second physical system, service machine 106N represents an n^{th} physical system (e.g., fifth or tenth). Available service machines 116 include service machine 106A, 106B, and 106N and represent the service machines for which service machine assignment program 110 can generate a digital twin and perform a digital twin simulation to identify a candidate service machine 106 to perform a procedure with respect to industrial machine 104. Service machine 106A, 106B, and 106N each respectively include microcontroller 114A, 114B, and 114N for transmitting various data to service machine assignment program 110 via network 108. The data service machine assignment program 110 receives from microcontroller 114A, 114B, and 114N allows for a creation of a digital twin for each of service machine 106A, 106B, and 106N and a digital twin simulation to identify a candidate service machine 106 to perform a procedure with respect to industrial machine 104.

Network 108 can be, for example, a telecommunications network, a local area network (LAN), a wide area network (WAN), such as the Internet, or a combination of the three, and can include wired, wireless, or fiber optic connections. Network 108 can include one or more wired and/or wireless networks capable of receiving and transmitting data, voice, and/or video signals, including multimedia signals that include voice, data, and video information. In general, network 108 can be any combination of connections and protocols that will support communications between server computer 102, industrial machine 104, service machine 106A, 106B, and 106N, and other computing devices (not shown) within the distributed data processing environment.

Service machine assignment program 110 identifies industrial machine 104 requiring assistance from service machine 106 and identifies a location for industrial machine 104 on a manufacturing or a warehouse floor. Service machine assignment program 110 identifies a policy for the location with industrial machine 104, where the policy includes various rules and parameters for operating industrial machine 104 and any service machine 106 assisting industrial machine 104 on the manufacturing or warehouse floor. Service machine assignment program 110 identifies available service machines 116 for assistance and performs a digital twin simulation for each service machine 106 of available service machines 116 based on the identified policy for the location. Based on the digital twin simulation, service machine assignment program 110 identifies a candidate service machine (e.g., service machine 106B) and determines a procedure for the candidate service machine performing one or more actions with respect to industrial machine 104. Service machine assignment program 110 performs the procedure for the candidate service machine and monitors the progress to identify any deviations. If a deviation from the procedure for the candidate service machine is detected, service machine assignment program 110 terminates the procedure for the candidate service machine to ensure maximize efficiency of the action with respect to industrial machine 104, while minimizing risk to the surrounding persons and area at the location.

Database 112 is a repository that stores various operational data from industrial machine 104, service machine 106A, 106B, and 106N, floorplans (e.g., manufacturing floor, warehouse floor), manufacturer operational specifications for each known service machine 106A, 106B, and 106N, historical operational data for service machine 106A, 106B, and 106N, maintenance history for industrial machine 104, and any other data pertinent to service machine assignment program 110 identifying a candidate service machine for preforming a procedure with regards to industrial machine 104. In the depicted embodiment, database 112 resides on server computer 102. A database is an organized collection of data, where database 112 can be implemented with any type of storage device capable of storing data and configuration files that can be accessed and utilized by service machine assignment program 110, such as a database server, a hard disk drive, or a flash memory.

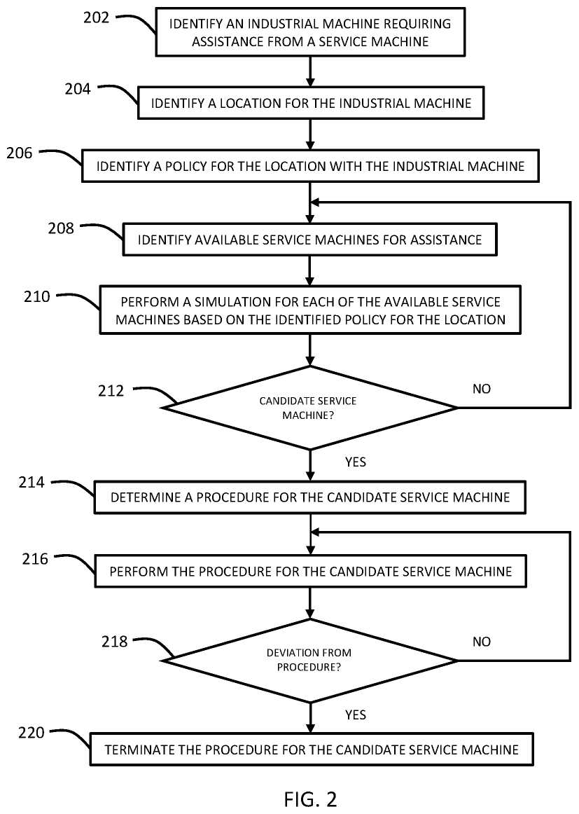

FIG. 2 is a flowchart depicting operational steps of a service machine assignment program for authenticating a service machine through simulation for interacting with an industrial machine, in accordance with an embodiment of the present invention.

Service machine assignment program 110 identifies an industrial machine requiring assistance from a service machine (202). The industrial machine requiring assistance from the service machine represents an instance where an interaction is to occur between the industrial machine and the service machine, where the service machine is to perform a procedure with respect to the industrial machine. The industrial machine is positioned in an industrial location, such as, a manufacturing floor or a warehouse floor. In one embodiment, service machine assignment program 110 identifies an industrial machine (e.g., a spot weld machine) requiring assistance from a service machine (e.g., a powered jack) due to scheduled maintenance, where a pallet of supplies is to be brought to the industrial machine to perform the scheduled maintenance. In another embodiment, service machine assignment program 110 identifies an industrial machine (e.g., electrical generator) requires assistance from a service machine (e.g., a mobile crane) due to a component failure requiring repair, where the industrial machine requires the mobile crane to lift and remove the failed component. In yet another embodiment, service machine assignment program 110 identifies an industrial machine (e.g., a conveyer) requiring assistance from a service machine (e.g., a powered jack) due to the industrial machine being removed from the location. Due to the size of the industrial machine, service machine assignment program 110 identifies the industrial machine requires assistance from two separate service machine to remove the industrial item from the location.

Service machine assignment program 110 identifies a location for the industrial machine (204). In this embodiment, service machine assignment program 110 stories various floorplans for the industrial location in which the industrial machine is positioned. As mentioned above, the industrial location can be a manufacturing or a warehouse facility. Each floorplan can include a layout detailing various stationary industrial machines, movement paths of mobile industrial machines, walls, pillars, stairs, ramps, loading docks, weight limits, height restrictions, width restriction, and any other information that can affect how objects (e.g., industrial machine or service machines) are positioned or move within the floorplan. Based on the floorplan in which the industrial machine is located, service machine assignment program 110 identifies the location for the industrial machine utilizing a unique identifier (e.g., serial number) associated with the industrial machine requiring assistance. In other embodiments, service machine assignment program 110 identifies a location for the industrial machine utilizing a geolocation system, such as, a Wi-Fi position system (WPS) to identify a Wi-Fi network to which the industrial machine is connected and a position for the industrial machine within the identified Wi-Fi network.

Service machine assignment program 110 identifies a policy for the location with the industrial machine (206). The policy for the location includes various rules and parameters for operating the industrial machine and any service machine assisting the industrial machine on the manufacturing or warehouse floor. The rules can define authorized actions by the service machine at the location, restricted actions by the service machine at the location, one or more required safety features of the service machine, operator defined limitations (e.g., remove current industrial machine through a specified loading dock), and any other nonvalue-based limitations associated with the service machine, the industrial machine, and the location. The parameters are value-based limitations associated with the service machine, the industrial machines, and the location. The parameters can define weight restrictions at the location, height restrictions at the location, width restriction at the location, length restriction at the location, speed restrictions at the location, a minimum load capacity of the service machine, and maximum dimensions for the service machine.

Service machine assignment program 110 identifies available service machines for assistance (208). Service machine assignment program 110 identifies available service machines for assistance based on the industrial machine, the required assistance, the location, the policy, and a desired time for the required assistance. For example, an electrical generator is positioned on a manufacturing floor and service machine assignment program 110 previously identified the electrical generator as an industrial machine with a component failure requiring repair. Service machine assignment program 110 determines that a mobile crane (i.e., service machine) is required to lift and remove the failed component on the electrical generator. Service machine assignment program 110 identifies available mobile cranes for operating within the confines of the manufacturing floor. In another example, a spot weld machine is positioned on a manufacturing floor and service machine assignment program 110 previously identified the spot weld machine as an industrial machine with a due scheduled maintenance. Service machine assignment program 110 determines that a powered jack (i.e., service machine) is required to move a pallet of supplies to the spot weld machine on the manufacturing floor. Service machine assignment program 110 identifies available powered jacks for operating within the confines of the manufacturing floor. In yet another example, a conveyer machine is positioned on a warehouse floor and service machine assignment program 110 previously identified the conveyer as an industrial machine that is to be removed from the warehouse floor. Service machine assignment program 110 determines that a powered jack (i.e., service machine) is required to remove the conveyer machine from the warehouse floor. Service machine assignment program 110 identifies available powered jacks for operating within the confines of the warehouse floor.

Service machine assignment program 110 performs a simulation for each of the available service machines based on the identified policy for the location (210). In this embodiment, service machine assignment program 110 performs a digital twin simulation for each of the available service machines based on the identified policy for the location, where service machine assignment program 110 generates a digital twin of each of the available service machines based on known manufacturer specification data and historical operational sensory data. The digital twin simulation combines elements of Artificial Intelligence (AI) enabled simulation with cloud computing to create a digital environment (i.e., digital location) in which the industrial machine and service machine operate. Service machine assignment program 110 can utilize the manufacturer specification data and historical operational sensory data for each of the available service machines to perform the digital twin simulation to determine whether a service machine can perform a procedure with respect to the industrial machine at the location. Service machine assignment program 110 generates a digital twin of each available service machine, where the digital twin is a virtual model designed to accurately reflect each available service machine. Each available service machine (e.g., powered jack, mobile crane) include numerous sensors related to various functional areas that produce operational sensory data as the service machine operates. Service machine assignment program 110 utilizes the historical operational sensory data, along with a floorplan for the location from (204) and the identified policy for the location from (206), to simulate how the service machine will operate within the confines of the floorplan for the location while assisting the industrial machine. Performing the digital twin simulation allows for service machine assignment program 110 to determine whether each of the available service machines can assist the industrial machine by performing a procedure within the confines of the floorplan for the location.

Through the digital twin simulation, service machine assignment program 110 can identify any potential issue that might arise if a specific service machine was to perform the procedure within the confines of the floorplan for the location. Service machine assignment program 110 can identify a service machine which can perform the procedure within the confines of the floorplan for the location in the least amount of time with respect to the other available service machines, thus resulting in reduce downtime and adversely impacting productivity. Service machine assignment program 110 can identify potential hazardous situations for each of the available service machines performing the procedure within the confines of the floorplan for the location. For example, service machine assignment program 110 can identify instances where a specific service machine may approach or contact a stationary object (e.g., pillar or another industrial machine) at the location and determine that the specific service machine cannot perform the procedure without an increased risk for potential hazardous situations. Service machine assignment program 110 improves on efficiency and safety on the manufacturing or warehouse floor, thus result in various benefits to supply chains manufacturing and/or handling goods.

Service machine assignment program 110 determines whether a candidate service machine is available (decision 212). In the event service machine assignment program 110 determines a candidate service machine is available (“yes” branch, decision 212), service machine assignment program 110 determines a procedure for the candidate service machine (214). In the event service machine assignment program 110 determines a candidate service machine is not available (“no” branch, decision 212), service machine assignment program 110 reverts to identifying available service machines for assistance (208). Service machine assignment program 110 determines whether a candidate service machine is available from the previously identified available service machines to assist the industrial machine based on the results of the digital twin simulation. Service machine assignment program 110 authenticates whether a specific service machine from the available service machines can perform a procedure of assisting the industrial machine and subsequent to authentication, service machine assignment program 110 determines that the specific service machine is a candidate service machine for performing the procedure of assisting the industrial outside of the digital twin simulation (i.e., a physical setting). For instances where service machine assignment program 110 determines multiple candidate service machines are available, service machine assignment program 110 can select a single candidate service machine based on defined parameters and/or a selection by an operation. Defined parameters can include selecting a candidate service machine that performed the procedure in the digital twin simulation in the least amount of time or selecting a candidate service machine with the lowest risk for potential hazardous situations.

Service machine assignment program 110 determines a procedure for the candidate service machine (214). Service machine assignment program 110 determines a procedure for the candidate service machine based on the industrial machine, the location, and the policy for the location. The procedure dictates actions to be taken by the candidate service machine while assisting the industrial machine located on the manufacturing or warehouse floor. For the procedures, service machine assignment program 110 can determine a movement path for the candidate service machine to ensure efficient and safe movement of the candidate service machine through the floorplan at the location with the industrial machine. Service machine assignment program 110 can also determine configurations for the candidate service machine as the candidate service machine moves across the movement path. For example, if a low support beam is present along the movement path, service machine assignment program 110 determines to configure the candidate service machine by instructing a mobile crane (i.e., the candidate service machine) to rotate and lower a boom to avoid striking the low support beam along the movement path. Service machine assignment program 110 can identify an operator provided rules or instructions for inclusion into the procedure. For example, if the industrial machine is to be relocated within a warehouse floor, service machine assignment program 110 can receive the operator provided instructions that includes a new location and a relocation movement path for the candidate service machine for assisting the industrial machine with the relocation within the warehouse floor.

Service machine assignment program 110 performs the procedure for the candidate service machine (216). In one embodiment, service machine assignment program 110 performs the procedure for the candidate service machine by instructing the candidate service machine to perform the procedure of assisting the industrial machine, where the candidate service machine operates in an autonomous, semi-autonomous, or manual manner with a designated operator. Service machine assignment program 110 can send the procedure directly to the candidate service machine and/or a device associated with the designated operator of the candidate service machine. To ensure the correct candidate eservice machine is utilized to perform the procedure, service machine assignment program 110 can assign an authentication key to the procedure based on a unique identifier (e.g., serial number) for the candidate service machine performing the procedure and verify the authentication key for the candidate service machine. In another embodiment, service machine assignment program 110 performs the procedure for the candidate service machine by remotely operating the candidate service machine and assisting the industrial machine based on the determined procedure. Service machine assignment program 110 monitors a progress of the candidate service machine to ensure no deviation is occurring from the procedure.

Service machine assignment program 110 determines whether a deviation from the procedure has occurred by the candidate service machine (decision 218). In the event service machine assignment program 110 determines a deviation from the procedure has occurred (“yes” branch, decision 218), service machine assignment program 110 terminates the procedure for the candidate service machine (220). In the event service machine assignment program 110 determines a deviation from the procedure has not occurred (“no” branch, decision 218), service machine assignment program 110 continues to perform the procedure from the candidate service machine (216).

A deviation from the procedure can include a breach of the designated movement path by the candidate service machine, an incorrect configuration of the candidate service machine, an incorrect action taken by the candidate service machine (e.g., slide versus lift), an exceeding of a designated speed, and a shock outside of an operating range (e.g., an impact) experienced by the candidate service machine. In one example, service machine assignment program 110 monitors a procedure being performed by a mobile crane (i.e., candidate service machine) to assist with a failed component repair on an electrical generator (i.e., industrial machine). As the procedure is being performed by the mobile crane, service machine assignment program 110 determines a deviation from the procedure has occurred by the mobile crane when a boom was extended beyond a predetermined amount, which can strike low support beam based on the layout for the manufacturing floor at the location. In another example, service machine assignment program 110 monitors a procedure being performed by a powered jack (i.e., candidate service machine) to assist with schedule maintenance on a spot weld machine (i.e., industrial machine). As the procedure is being performed by the powered jack, service machine assignment program 110 determines a deviation from the procedure has occurred by the powered jack when an operator of the powered jack deviated from a designated movement path. In yet another example, service machine assignment program 110 monitors a procedure being performed by a powered jack (i.e., candidate service machine) to assist with a removal of a conveyer (i.e., industrial machine) from a warehouse floor. As the procedure is being performed by the powered jack, service machine assignment program 110 determines a deviation from the procedure when a load limit on the powered jack was exceeded due to unforeseen loads being applied to the powered jack in addition to the weight of the conveyer being moved.

Service machine assignment program 110 terminates the procedure for the candidate service machine (220). Service machine assignment program 110 terminates the procedure for the candidate service machine to ensure the safety of the operator and/or users in the surrounding area of the candidate service machine, to protect the surrounding area from damage by the candidate service machine, and to protect the candidate service machine from damage. In one embodiment, service machine assignment program 110 instructs the candidate service machine to perform an emergency stop function, where service machine assignment program 110 requires input from an operator to manually override the emergency stop function. In another embodiment, service machine assignment program 110 terminates the procedure but allows for the candidate service machine to continue operating in a semi-autonomous or manual manner. Service machine assignment program 110 can track each instance of a deviation from the procedure and generate a report with a list of the deviation from the procedure. Service machine assignment program 110 can send the report with the list of the deviation from the procedure to a location supervisor and/or a supervisor of the operator for the candidate service machine.

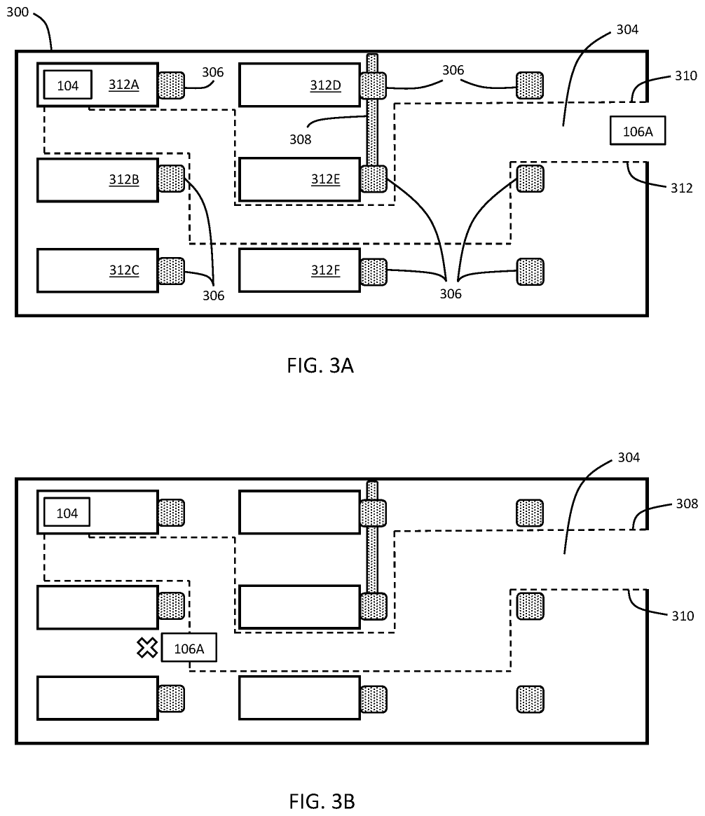

FIG. 3A illustrates an overhead view of a movement path associated with a procedure for a candidate service machine, in accordance with an embodiment of the present invention. As previously discussed, service machine assignment program 110 determines a procedure for service machine 106A (i.e., candidate service machine) based on industrial machine 104, a location of industrial machine 104, and a policy for the location of industrial machine 104. The procedure dictates actions to be taken by service machine 106A while assisting industrial machine 104 located on a manufacturing floor at the location. For the procedures, service machine assignment program 110 utilizes floorplan 300 for the manufacturing floor to determine movement path 304 for service machine 106A to ensure efficient and safe movement of service machine 106A through floorplan 300 at the location. Floorplan 300 includes locations for pillars 306 and wall 308, through which service machine 106A cannot pass through. Floorplan 300 also includes a location for support tables 312A, 312B, 312C, 312D, 312E, and 312F, where industrial machine 104 is positioned on support table 312A and service machine 106A cannot pass through support tables 312A, 312B, 312C, 312D, 312E, and 312F. Service machine assignment program 110 generates movement path 304 with boundaries 310 and 312 on which service machine 106A is to travel to assist industrial machine 104.

FIG. 3B illustrates an overhead view of a deviation of the movement path associated with a procedure for a candidate service machine, in accordance with an embodiment of the present invention. As service machine 106A performs a procedure by traveling to assist industrial machine 104, service machine assignment program 110 monitors the movement and configuration of service machine 106A. Service machine assignment program 110 determines a deviation from the procedure for service machine 106A has occurred when service machine 106A crosses boundary 312 of movement path 304. Service machine assignment program 110 terminates the procedure for service machine 106A to ensure the safety of the operator and/or users in the surrounding area of service machine 106A, to protect the surrounding area (e.g., pillars 306 and wall 308) from damage by service machine 106, and to protect service machine 106A from damage.

In various embodiments of the present invention, service machine assignment program 110 can receive a digital twin model of a service machine and simulate against an activity (e.g., repair, removal) performable on a manufacturing or warehouse floor with regards to an industrial machine. Based on the simulation, service machine assignment program 110 can authorize the service machine on the manufacturing or warehouse floor if the digital twin simulation identifies a candidate service machine to perform the activity as per a policy as defined for the manufacturing or warehouse floor. Service machine assignment program 110 can analyze the method of performing the activity on the manufacturing or warehouse floor by the service machine with associated accessories and service machine assignment program 110 can authenticate the service machine with associated accessories (e.g., hoist). Service machine assignment program 110 can send corrections or alterations to apply to the service machine to allow the service machine onto the manufacturing or warehouse floor to perform the activity. Furthermore, service machine assignment program 110 can include a list of additional external accessories (e.g., additional hoist to assist with lifting or rubberized wheels to prevent damage to the manufacturing floor) required for the service machine to perform the activity and can authorize the procedure. Service machine assignment program 110 can receive the digital twin model of the service machine and simulate the activity on the manufacturing or warehouse floor to identify a level of access to perform the activities in the surrounding area (e.g., the external machine is allowed to remove the machine but will not be allowed to install a new machine).

FIG. 4 depicts computer system 400, where server computer 102 is an example of a computer system 400 that includes service machine assignment program 110. The computer system includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

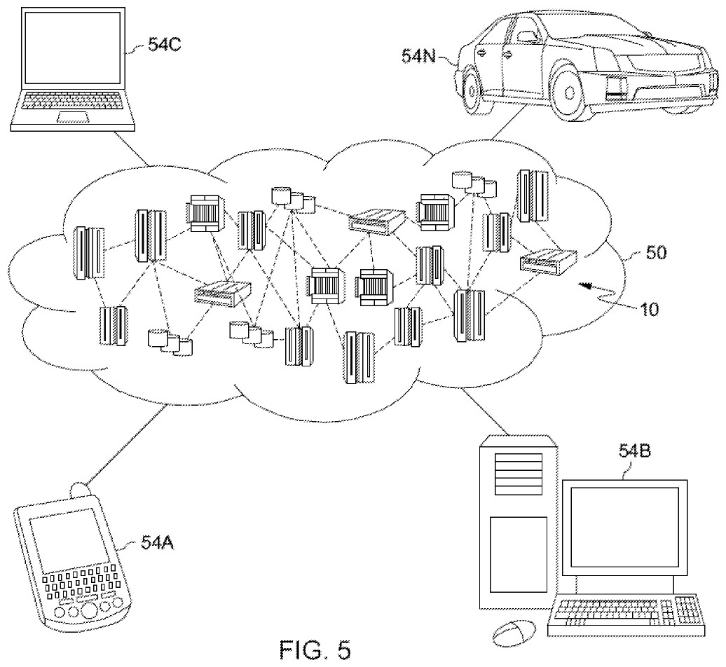

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

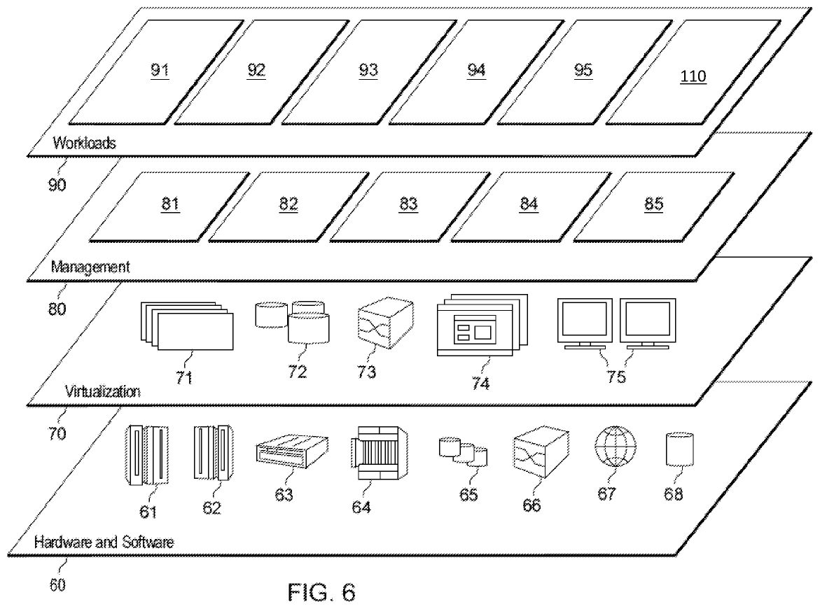

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service machine assignment program 110.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
responsive to identifying an industrial machine requiring assistance from a service machine, identifying a location for the industrial machine, wherein the location associated with an industrial setting;
identifying a plurality of available service machines to provide assistance to the industrial machine;
performing a simulation of each of the plurality of available service machines based on the assistance to the industrial machine and a policy for the location;
responsive to identifying a candidate service machine from the plurality of available service machines, determining a procedure performable by the candidate service machine, wherein the procedure provides assistance to the industrial machine; and
performing the procedure for the candidate service machine.

2. The computer-implemented method of claim 1, wherein performing the simulation of each of the plurality of available service machines further comprises:
generating a digital twin model for each of the plurality of available service machines based on manufacturer specification data and historical operational sensory data;
simulating, for each digital twin model, a digital procedure for assisting the industrial machine at the location based on the assistance to the industrial machine, the policy for the location, and a floorplan for the location; and
identifying, based on the simulation, the candidate service machine from the plurality of available service machines for performing the procedure.

3. The computer-implemented method of claim 2, further comprising:
identifying the policy for the location, wherein the policy for the location includes rules and parameters for operating the industrial machine and the plurality of available service machines at the location.

4. The computer-implemented method of claim 1, wherein performing the procedure for the candidate service machine further comprises:
assigning an authentication key to the procedure based on a unique identifier for the candidate service machine; and
responsive to verifying the authentication key for the candidate service machine, instructing the candidate service machine to perform the procedure that provides assistance to the industrial machine.

5. The computer-implemented method of claim 1, further comprising:
responsive to determining a deviation from the procedure by the candidate service machine has occurred, terminating the procedure for the candidate service machine.

6. The computer-implemented method of claim 5, wherein the deviation is selected from the group consisting of: an incorrect configuration for the candidate service machine, an incorrect action taken by the candidate service machine, an exceeding of a designated speed, and a shock outside of an operating range experienced by the candidate service machine.

7. The computer-implemented method of claim 1, wherein the procedure that provides assistance to the industrial machine includes the candidate service machine performing at least one action with respect to the industrial machine.

8. A computer program product comprising one or more computer readable storage media and program instructions collectively stored on the one or more computer readable storage media, the stored program instructions executable by one or more computer processors, the stored program instructions comprising:
responsive to identifying an industrial machine requiring assistance from a service machine, identifying a location for the industrial machine, wherein the location associated with an industrial setting;
identifying a plurality of available service machines to provide assistance to the industrial machine;
performing a simulation of each of the plurality of available service machines based on the assistance to the industrial machine and a policy for the location;
responsive to identifying a candidate service machine from the plurality of available service machines, determining a procedure performable by the candidate service machine, wherein the procedure provides assistance to the industrial machine; and
performing the procedure for the candidate service machine.

9. The computer program product of claim 8, wherein performing the simulation of each of the plurality of available service machines, the stored program instructions further comprises:
generating a digital twin model for each of the plurality of available service machines based on manufacturer specification data and historical operational sensory data;
simulating, for each digital twin model, a digital procedure for assisting the industrial machine at the location based on the assistance to the industrial machine, the policy for the location, and a floorplan for the location; and
identifying, based on the simulation, the candidate service machine from the plurality of available service machines for performing the procedure.

10. The computer program product of claim 9, the stored program instructions further comprising:
identifying the policy for the location, wherein the policy for the location includes rules and parameters for operating the industrial machine and the plurality of available service machines at the location.

11. The computer program product of claim 8, wherein performing the procedure for the candidate service machine, the stored program instructions further comprises:
assigning an authentication key to the procedure based on a unique identifier for the candidate service machine; and
responsive to verifying the authentication key for the candidate service machine, instructing the candidate service machine to perform the procedure that provides assistance to the industrial machine.

12. The computer program product of claim 8, the stored program instructions further comprising:
responsive to determining a deviation from the procedure by the candidate service machine has occurred, terminating the procedure for the candidate service machine.

13. The computer program product of claim 12, wherein the deviation is selected from the group consisting of: an incorrect configuration for the candidate service machine, an incorrect action taken by the candidate service machine, an exceeding of a designated speed, and a shock outside of an operating range experienced by the candidate service machine.

14. The computer program product of claim 8, wherein the procedure that provides assistance to the industrial machine includes the candidate service machine performing at least one action with respect to the industrial machine.

15. A computer system comprising:
one or more computer processors;
one or more computer readable storage media; and
program instructions stored on the computer readable storage media for execution by at least one of the one or more computer processors, the program instructions comprising:
responsive to identifying an industrial machine requiring assistance from a service machine, identifying a location for the industrial machine, wherein the location associated with an industrial setting;
identifying a plurality of available service machines to provide assistance to the industrial machine;
performing a simulation of each of the plurality of available service machines based on the assistance to the industrial machine and a policy for the location;
responsive to identifying a candidate service machine from the plurality of available service machines, determining a procedure performable by the candidate service machine, wherein the procedure provides assistance to the industrial machine; and
performing the procedure for the candidate service machine.

16. The computer system of claim 15, wherein performing the simulation of each of the plurality of available service machines, the stored program instructions further comprises:
generating a digital twin model for each of the plurality of available service machines based on manufacturer specification data and historical operational sensory data;
simulating, for each digital twin model, a digital procedure for assisting the industrial machine at the location based on the assistance to the industrial machine, the policy for the location, and a floorplan for the location; and
identifying, based on the simulation, the candidate service machine from the plurality of available service machines for performing the procedure.

17. The computer system of claim 16, the stored program instructions further comprising:
identifying the policy for the location, wherein the policy for the location includes rules and parameters for operating the industrial machine and the plurality of available service machines at the location.

18. The computer system of claim 15, wherein performing the procedure for the candidate service machine, the stored program instructions further comprises:
assigning an authentication key to the procedure based on a unique identifier for the candidate service machine; and
responsive to verifying the authentication key for the candidate service machine, instructing the candidate service machine to perform the procedure that provides assistance to the industrial machine.

19. The computer system of claim 15, the stored program instructions further comprising:
responsive to determining a deviation from the procedure by the candidate service machine has occurred, terminating the procedure for the candidate service machine.

20. The computer system of claim 19, wherein the deviation is selected from the group consisting of: an incorrect configuration for the candidate service machine, an incorrect action taken by the candidate service machine, an exceeding of a designated speed, and a shock outside of an operating range experienced by the candidate service machine.
